(19) United States
(12) Patent Application Publication
(10) Pub. No.: US 2013/0082217 A1
(43) Pub. Date: Apr. 4, 2013

(54) METHOD OF PRODUCING METAL PARTICLES, AND INK COMPOSITION AND PASTE COMPOSITION PRODUCED BY THE SAME

(71) Applicants: Sung Koo Kang, Gyunggi-do (KR); Ro Woon Lee, Gyunggi-do (KR); Dong Hoon Kim, Gyunggi-do (KR)

(72) Inventors: Sung Koo Kang, Gyunggi-do (KR); Ro Woon Lee, Gyunggi-do (KR); Dong Hoon Kim, Gyunggi-do (KR)

(73) Assignee: SAMSUNG ELECTRO-MECHANICS CO., LTD., Gyunggi-do (KR)

(21) Appl. No.: 13/304,259

(22) Filed: Nov. 23, 2011

(30) Foreign Application Priority Data
Sep. 29, 2011 (KR) 1020110099219

(51) Int. Cl. H01B 1/22; C09D 11/02; B22F 9/18

(52) U.S. Cl. 252/514; 75/370; 106/31.92

(57) ABSTRACT

Disclosed is a method of producing metal particles, including preparing a first solution including a silver (Ag) compound and a solvent, heating and stirring the first solution, adding an organophosphorus compound to the first solution and heating the first solution, and forming metal particles capped with a phosphorus (P) compound from the first solution.

### CROSS REFERENCE TO RELATED APPLICATION

This application claims the benefit of Korean Patent Application No. 10-2011-0099219, filed Sep. 29, 2011, entitled “Method for producing metal particles, ink composition and paste composition produced by the same,” which is hereby incorporated by reference in its entirety into this application.

### BACKGROUND OF THE INVENTION

1. Technical Field

The present invention relates to a method of producing metal particles, and an ink composition and a paste composition produced using the same.

2. Description of the Related Art

Because conventional energy sources such as petroleum or coal will be exhausted in the future, it is becoming crucial to devise alternative energy sources. Solar cells are receiving particular attention because the energy sources thereof are rich and there are no environmental contamination problems.

Solar cells are classified into solar thermal cells that generate vapor necessary for rotating a turbine using solar heat and into photovoltaic cells that convert photons to electric energy using the properties of a semiconductor, and the solar cell is typically called a photovoltaic cell (hereinafter referred to as a solar cell).

Also, solar cells are divided into, depending on the type of material, a silicon solar cell, a compound semiconductor solar cell, and a tandem solar cell. Among these three solar cells, the silicon solar cell is mainly used for the sake of stability and high efficiency.

However, a silicon solar cell is problematic because contact resistance between the surface of silicon and the front electrode is high. Hence, thorough research into an emitter for decreasing the contact resistance between the surface of silicon and the front electrode is ongoing.

Meanwhile, FIG. 1 of Korean Patent Publication No. 2010-0078813 shows a cross-sectional view of a solar cell including a selective emitter in which the structure of an emitter layer is changed according to a conventional technique.

Specifically, this solar cell includes a p-type semiconductor substrate 101 and an n-type semiconductor layer 102 which form pn heterojunction, a front electrode 104 formed thereon, and a rear electrode 106 formed on the lower surface of the p-type semiconductor substrate 101.

The n-type semiconductor layer 102 includes, as an emitter layer, a selective emitter layer which is configured such that, in order to reduce the contact resistance with the front electrode 104, a portion thereof in contact with the electrode is formed thicker and the other portion thereof is formed to be thinner.

Although such a selective emitter layer reduces the contact resistance between the electrode and the emitter layer and is thus very favorable in terms of efficiency, an additional process is added and thus the manufacturing process is complicated, and the production cost is too high. Thus there is a need to solve the manufacturing process problems of the selective emitter layer.

### SUMMARY OF THE INVENTION

Accordingly, the present invention has been made keeping in mind the problems encountered in the related art and an aspect of the present invention is to provide a method of producing metal particles, which is capable of forming a selective emitter layer at the same time of forming an electrode, and an ink composition and a paste composition produced using the same.

Another aspect of the present invention is to provide a method of producing metal particles, which is capable of preventing the corrosion of a metal head that discharges an ink composition upon using an ink-jet printing process, and an ink composition and a paste composition produced using the same.

In order to accomplish the above aspects, according to an embodiment of the present invention, a method of producing metal particles is provided, which comprises preparing a first solution comprising a silver (Ag) compound and a solvent, heating and stirring the first solution, adding an organophosphorus compound to the first solution and heating the first solution, and forming metal particles capped with a phosphorus (P) compound from the first solution.

As such, the silver (Ag) compound may be silver nitrate (AgNO₃),

Also, upon preparing the first solution, the first solution may further comprise butyl amine, and the method may further comprise adding an amine to the first solution before adding the organophosphorus compound to the first solution and heating the first solution.

Also, forming the metal particles may comprise adding an acid to the first solution to deposit the metal powder particles capped with the phosphorus (P) compound and washing and drying the deposited powder particles.

The organophosphorus compound may be alkyl phosphate or alkyl phosphonate.

On the other hand, the silver (Ag) compound may be silver (Ag) powder, and the organophosphorus compound may be organophosphate or organophosphonate.

Furthermore, the organophosphorus compound may have 8˜22 carbons.

In addition, according to another embodiment of the present invention, a method of producing an ink composition is provided, which comprises preparing a first solution comprising a silver (Ag) compound and a solvent, heating and stirring the first solution, adding an organophosphorus compound to the first solution and heating the first solution, forming metal particles capped with a phosphorus (P) compound from the first solution, and adding a viscosity controlling agent and a dispersant to the first solution.

As such, the silver (Ag) compound may be silver nitrate (AgNO₃),

Also, upon preparing the first solution, the first solution may further comprise butyl amine, and the method may further comprise adding an amine to the first solution before adding the organophosphorus compound to the first solution and heating the first solution, and furthermore, forming the metal particles may be performed by adding an acid to the first solution.

The organophosphorus compound may be alkyl phosphate or alkyl phosphonate.

On the other hand, the silver (Ag) compound may be silver (Ag) powder, and the organophosphorus compound may be organophosphate or organophosphonate.

Furthermore, the organophosphorus compound may have 8˜22 carbons.

Also, the viscosity controlling agent may be added in an amount of 20 wt % or less, and the dispersant may be added in an amount of 20 wt % or less, based on the total weight of the ink composition.

Also, the amount of the metal particles may be 60 wt % or less, based on the total weight of the ink composition.

In addition, according to a further embodiment of the present invention, an ink composition is provided, which comprises metal particles capped with a phosphorus (P) compound, a solvent which disperses the metal particles, a viscosity controlling agent which controls viscosity of ink, and a dispersant which increases dispersibility of ink.

As such, the metal particles capped with the phosphorus (P) compound may be provided in a form wherein phosphorus (P) of the phosphorus (P) compound is adsorbed onto the surface of the metal particles.

Also, the metal particles capped with the phosphorus (P) compound may be provided in a form wherein a functional group of the phosphorus (P) compound is adsorbed onto the surface of the metal particles.

The metal particles may be silver (Ag).

Also, the viscosity controlling agent may be added in an amount of 20 wt % or less, the dispersant may be added in an amount of 20 wt % or less, and the amount of the metal particles may be 60 wt % or less, based on the total weight of the ink composition.

### BRIEF DESCRIPTION OF THE DRAWINGS

FIG. 1 is a flowchart showing a process of producing metal particles according to an embodiment of the present invention;

FIG. 2 is a view showing metal particles capped with a phosphorus (P) compound when silver nitrate (AgNO₃) is used as a silver (Ag) compound;

FIG. 3 is a view showing metal particles capped with a phosphorus (P) compound when silver (Ag) powder is used as a silver (Ag) compound; and

FIG. 4 is a transmission electron microscope (TEM) image showing silver (Ag) particles capped with a phosphorus (P) compound when silver (Ag) powder is used as a silver (Ag) compound.

### DESCRIPTION OF SPECIFIC EMBODIMENTS

The features and advantages of the present invention will be more clearly understood from the following detailed description and embodiments. Throughout the drawings, the same reference numerals are used to refer to the same or similar elements. Furthermore, descriptions of known techniques, even if they are pertinent to the present invention, are regarded as unnecessary and may be omitted when they would make the characteristics of the invention and the description unclear. In the description, the terms “first”, “second” and so on are used to distinguish one element from another element, and the elements are not defined by the above terms.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Hereinafter, a detailed description will be given of embodiments of the present invention with reference to the appended drawings.

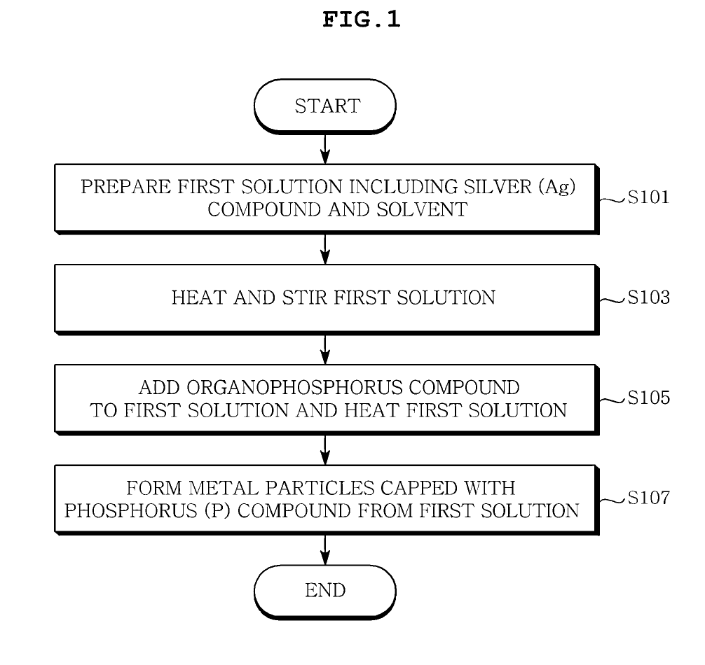

FIG. 1 is a flowchart showing a process of producing metal particles according to an embodiment of the present invention.

With reference to FIG. 1, the method of producing metal particles according to the embodiment of the present invention includes preparing a first solution including a silver (Ag) compound and a solvent (S101), heating and stirring the first solution (S103), adding an organophosphorus compound to the first solution and heating the first solution (S 105), and forming metal particles capped with a phosphorus (P) compound from the first solution (S 107).

Herein, according to a first embodiment, the Ag compound may be silver nitrate (AgNO₃).

The solvent used is a non-aqueous solvent, which may be selected from the group consisting of hexane, toluene, xylene, chloroform, dichloromethane, tetradecane, octadecene, chlorobenzoic acid, 1-hexadecyne, 1-tetradecyne, 1-octadecyne and mixtures thereof, but is not necessarily limited thereto.

Upon preparing the first solution in the method of producing metal particles according to the embodiment of the present invention, the first solution may further include butyl amine, but is not necessarily limited thereto.

Also, the method of producing metal particles according to the embodiment of the present invention may further include adding an amine to the first solution, before adding the organophosphorus compound to the first solution and heating the first solution.

The amine may be selected from among saturated and unsaturated amines with at least one of C8˜C22 linear, branched and cyclic forms, and may be a primary amine or a secondary amine.

Specific examples of the amine include but are not necessarily limited to hexylamine, heptylamine, dodecylamine, oleylamine, etc.

In the present embodiment, the organophosphorus compound may be alkyl phosphate or alkyl phosphonate.

A specific example of the alkyl phosphate is dodecyl phosphate represented by Chemical Formula 1 below, etc., but is not necessarily limited thereto. Any alkyl phosphate or alkyl phosphonate may be used so long as it has 8˜22 carbons.

If the number of carbons is less than 8, dispersibility in the solvent may decrease. In contrast, if the number of carbons exceeds 22, organic content in the solution may undesirably increase.

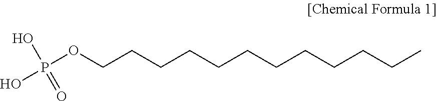 [SMILES: CCCCCCCCCCCCOP(=O)(O)O]

Subsequently, an acid is added to the first solution containing alkyl phosphate or alkyl phosphonate, so that Ag powder particles capped with a P compound may be deposited.

In the present embodiment, the acid functions as a reducing agent that reduces Ag ions to Ag particles, and may include but is not necessarily limited to formic acid.

Subsequently, the deposited Ag powder particles capped with a P compound are washed and dried.

As such, the washing process may include primary washing using ethanol and secondary washing using acetone, but is not necessarily limited thereto.

Furthermore, the drying process may be carried out in a vacuum oven, but is not necessarily limited thereto.

According to a second embodiment, the Ag compound may be Ag powder.

As such, a different solvent may be used to suit the properties of the Ag powder. For example, in the case where Ag powder synthesized in an aqueous system is used, a solvent such as ethylene glycol may be used. In contrast, in the case where Ag powder synthesized in a non-aqueous system is used, a solvent such as toluene or cyclohexane may be used. However, the present invention is not necessarily limited thereto.

Also, in the present embodiment, the organophosphorus compound added to the first solution may be organophosphate or organophosphonate.

Specific examples of the organophosphate may include phosphatidylcholine represented by Chemical Formula 2 below, triphenyl phosphate represented by Chemical Formula 3 below, etc.

Furthermore, specific examples of the organophosphonate may include zoledronic acid represented by Chemical Formula 4 below, glyphosate represented by Chemical Formula 5 below, etc.

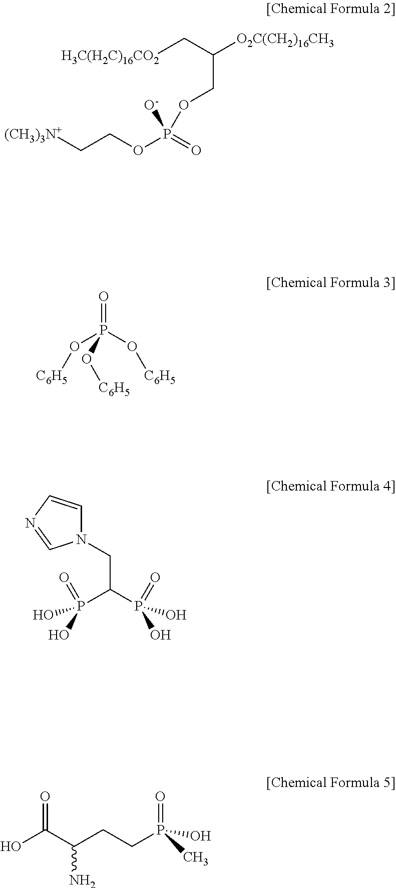

However, the above compounds are merely illustrative, and organophosphate and organophosphonate compounds used in the present embodiment are not necessarily limited to the above compounds. Alternatively useful are compounds having amphiphilic functional groups, namely, one functional group affinitive for Ag, for example, thiol, amine, carboxyl, imidazole or the like, and the other functional group containing P.

Subsequently, the Ag powder particles capped with a P compound are precipitated for a predetermined period of time, after which the precipitated powder is washed and dried.

As such, the washing process may include primary washing using ethanol and secondary washing using acetone, and the drying process may be conducted in a vacuum oven, but the present invention is not particularly limited thereto.

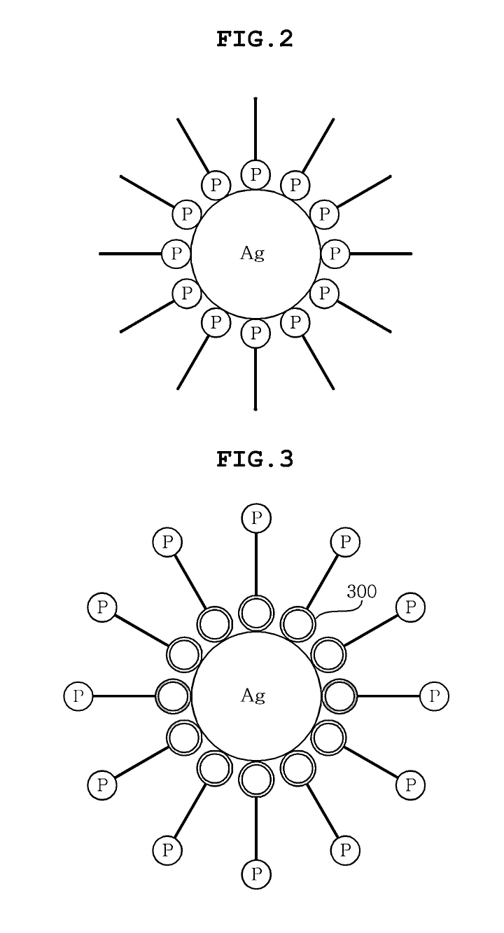

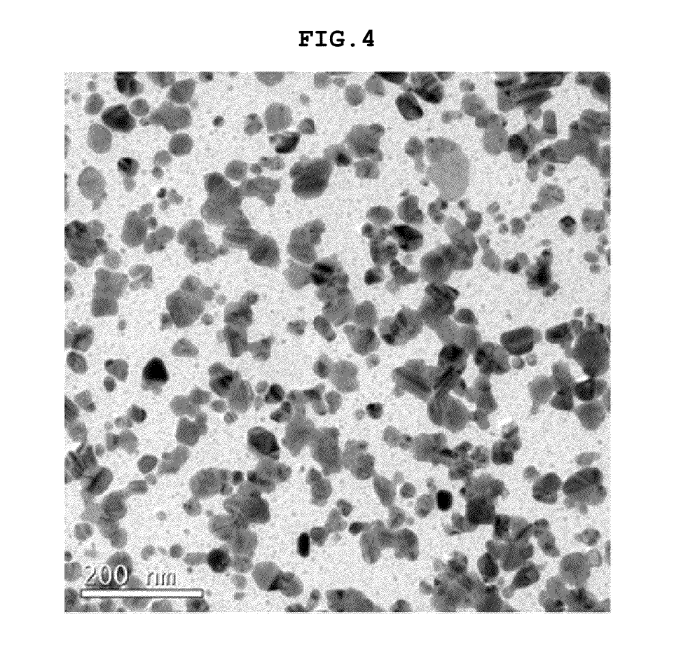

FIG. 2 shows the metal particles capped with a P compound when AgNO₃ is used as the Ag compound, and FIG. 3 shows the metal particles capped with a P compound when Ag powder is used as the Ag compound. FIG. 4 is a TEM image showing the Ag particles capped with a P compound when Ag powder is used as the Ag compound.

As shown in FIG. 2, the metal particles produced according to the first embodiment may be provided in the form of being capped by directly adsorbing P of the P compound such as alkyl phosphate or alkyl phosphonate onto the surface of the Ag particles.

The TEM image of the metal particles thus formed, namely, the Ag particles capped with P, is shown in FIG. 4.

Also as shown in FIG. 3, the metal particles produced using Ag powder and organophosphate or organophosphonate according to the second embodiment may be provided in the form of Ag particles being capped with P by adsorbing the functional group 300 of the P compound affinitive for Ag onto the surface of Ag.

In addition, a method of producing an ink composition according to another embodiment of the present invention includes preparing a first solution including an Ag compound and a solvent, heating and stirring the first solution, adding an organophosphorus compound to the first solution and heating the first solution, forming metal particles capped with a P compound from the first solution, and adding a viscosity controlling agent and a dispersant to the first solution.

The procedures up to forming the metal particles may be performed by either of the two embodiments in the method of producing metal particles as explained above, namely, using AgNO₃ or Ag powder as the Ag compound.

As such, the metal particles may be Ag, and the metal particles capped with a P compound may be provided in a form wherein, as shown in FIG. 2, the P of the P compound is adsorbed onto the surface of Ag particles, or a form wherein, as shown in FIG. 3, the functional group 300 of the P compound is adsorbed onto the surface of Ag particles.

The viscosity controlling agent is used to control the viscosity of the ink composition, and the amount of the viscosity controlling agent added to the first solution may be 20 wt % or less, particularly 1˜20 wt %, based on the total weight of the ink composition.

If the amount of the viscosity controlling agent is less than 1 wt %, no additional effects are obtained. In contrast, if the amount of the viscosity controlling agent exceeds 20 wt %, it is not easy to remove organic materials in a sintering process.

The dispersant is used to increase dispersibility of the metal particles, and the amount of the dispersant added to the first solution may be 20 wt % or less, particularly 1˜20 wt %, based on the total weight of the ink composition.

If the amount of the dispersant is less than 1 wt %, there are no additional effects. In contrast, if the amount of the dispersant exceeds 20 wt %, it is not easy to remove organic materials as mentioned above.

The metal particles may be contained in an amount of 60 wt % or less, particularly 10˜60 wt %, in the first solution.

If the amount of the metal particles is less than 10 wt %, Ag content of the ink composition is low, undesirably making it problematic to exhibit electrode properties after printing.

In contrast, if the amount of the Ag particles exceeds 60 wt %, the addition of solvent, viscosity controlling agent and dispersant may become problematic, and the ink composition cannot behave, making it difficult to perform printing.

The method of producing the ink composition according to the present embodiment may include the provision of the ink composition comprising the metal particles capped with a P compound, the solvent for dispersing the metal particles, the viscosity controlling agent for controlling the viscosity of ink, and the dispersant that improves the dispersibility of ink.

As such, the metal particles, the viscosity controlling agent and the dispersant may be added in amounts within the above ranges, with the balance being the solvent so that the total amount of the ink composition is 100 wt %.

When the ink composition comprising the Ag particles capped with a P compound is used, an ink-jet head may be prevented from corroding upon discharging the composition via the ink-jet head, compared to a conventional ink composition including phosphorus pentoxide (P₂O₅).

In addition, a method of producing a paste composition according to a further embodiment of the present invention includes dissolving an organic binder in a solvent, mixing the organic binder solution with metal particles capped with a P compound, adding glass powder, a plasticizer, and a thixotropic agent to the solution containing the metal particles, and milling the mixed solution.

Specifically, the metal particles capped with a P compound may be Ag particles capped with a P compound.

As such, the Ag particles capped with a P compound may be obtained by either of the two embodiments in the method of producing metal particles as explained above, namely, using AgNO₃ or Ag powder as the Ag compound.

The solvent may include a solvent having high vapor pressure with a comparatively high boiling point to prevent it from evaporating upon screen printing, and examples thereof include butyl carbitol acetate, butyl carbitol, α-terpineol, ethyl carbitol, and menthanol (which is dihydroterpineol), but are not necessarily limited thereto.

The Ag particles capped with a P compound may be contained in an amount of 95 wt % or less, particularly 50˜95 wt %, based on the total weight of the paste composition.

If the amount of the Ag particles is less than 50 wt %, the Ag content of the paste composition is very low, undesirably making it problematic to exhibit the electrode properties after printing.

In contrast, if the amount of the Ag particles exceeds 95 wt %, the addition of solvent, binder and additive may become problematic, and the paste composition cannot behave, making it difficult to perform printing.

Examples of the organic binder include but are not necessarily limited to cellulose derivatives, such as polyester, acryl, ethyl cellulose, etc., phenol and epoxy resins.

The organic binder may be contained in an amount of 10 wt % or less, particularly 0.5˜10 wt %, based on the total weight of the paste composition.

If the amount of the organic binder is less than 0.5 wt %, the paste composition cannot behave as expected. In contrast, if the amount thereof exceeds 10 wt %, it is difficult to exhibit electric properties after printing and sintering.

Also, the paste composition according to the present embodiment may further include additives, which include but are not necessarily limited to a thixotropic agent for adjusting thixotropy of the paste composition and a plasticizer for adjusting the processability and flexibility of the paste composition.

Examples of the thixotropic agent include but are not necessarily limited to castor wax, oxidized polyethylene wax, amide wax, dry silica (fumed silica or pyrogenic silica), etc.

When the thixotropic agent is added to the paste composition according to the present embodiment, the spreading of the paste out of a desired pattern upon printing may be suppressed.

Examples of the plasticizer include but are not necessarily limited to phthalate based compounds, such as dimethyl phthalate, diethyl phthalate, butyl decyl phthalate, etc.

Also, the paste composition according to the present embodiment may further include glass powder. Any glass powder may be used without limitation so long as it is employed in the art.

Examples of the glass powder may include lead oxide and/or bismuth oxide. Specifically, SiO₂—PbO powder, SiO₂—PbO—B₂O₃ powder, and PbO—Bi₂O₃—B₂O₃—SiO₂ powder may be used alone or in mixtures of two or more, but the present invention is not necessarily limited thereto.

The following examples are set forth to illustrate but are not to be construed as limiting the present invention.

### Example 1

A first solution comprising 30 g of AgNO₃, 1 L of toluene and 5 ml of butyl amine was prepared, and stirred at 40° C. so that AgNO₃ was dissolved.

Subsequently, to the first solution including dissolved AgNO₃ was added 20 ml of dodecyl phosphate, and the first solution was heated to 80° C. from 40° C.

Subsequently, while the first solution was being stirred, it was reduced with 2 ml of formic acid, so that Ag powder particles capped with P were deposited.

Subsequently, the deposited Ag powder particles were primarily washed with ethanol (EtOH), secondarily washed with acetone, and dried in a vacuum oven, thus obtaining Ag particles capped with P.

### Example 2

A first solution comprising 100 g of Ag powder and 1 L of toluene was prepared and stirred, after which 50 ml of dodecyl phosphate was added with stirring at 80° C.

1 hour later, the precipitated Ag powder particles capped with P were primarily washed with EtOH, secondarily washed with acetone, and dried in a vacuum oven, thus obtaining Ag particles capped with P.

### Example 3

60 g of tetradecane was heated and stirred at about 40° C., after which 40 g of Ag particles capped with P was added and stirred.

The mixture was stirred to the point of complete dissolution so that the bottom precipitate disappeared, after which 0.5 g of neo-decanoic acid was added, and the mixture was stirred for about 30 minutes.

During the stirring, the temperature was maintained at 40° C.

Subsequently, the mixture was centrifuged at 3000 rpm for 10 minutes to remove undissolved material, followed by filtering (0.5 μm pore filter).

### Example 4

12 g of an EC binder (EC 10) was dissolved in butyl carbitol acetate.

After the EC binder was dissolved, Ag particles capped with a P compound were mixed. (D50=2.5 μm, D50=300 nm, D50=30 nm in 620 g, 25 g, 5 g).

Glass powder (40 g), a plasticizer (dioctyl phthalate) (5 g), and a thixotropic agent (3 g) were mixed, and the mixture was milled using a 3-roll mill.

As described hereinbefore, the present invention provides a method of producing metal particles, and an ink composition and a paste composition produced using the same. According to the present invention, Ag particles capped with a P compound are used to prepare a composition for forming an electrode, thereby effectively forming a selective emitter layer at the same time of forming an electrode upon sintering the electrode thanks to self-doping effects achieved by the addition of dopant.

Also according to the present invention, the selective emitter layer can be formed while forming the electrode, thereby shortening the process time and reducing the production cost of a solar cell.

Also according to the present invention, a composition resulting from the Ag particles capped with a P compound is used, thus preventing the corrosion of an ink-jet head that discharges the composition upon ink jet printing, compared to when using a composition containing P₂O₅.

Although the embodiments of the present invention regarding the method of producing metal particles, the ink composition using the same and the production method thereof have been disclosed for illustrative purposes, those skilled in the art will appreciate that a variety of different modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A method of producing metal particles, comprising:
preparing a first solution comprising a silver (Ag) compound and a solvent;
heating and stirring the first solution;
adding an organophosphorus compound to the first solution and heating the first solution; and
forming metal particles capped with a phosphorus (P) compound from the first solution.

2. The method of claim 1, wherein the silver (Ag) compound is silver nitrate (AgNO₃),
in the preparing the first solution, the first solution further comprises butyl amine,
the method further comprises adding an amine to the first solution before adding the organophosphorus compound to the first solution and heating the first solution, and
the forming the metal particles comprises:
adding an acid to the first solution to deposit metal powder particles capped with the phosphorus (P) compound; and
washing and drying deposited powder particles.

3. The method of claim 2, wherein the organophosphorus compound is alkyl phosphate or alkyl phosphonate.

4. The method of claim 1, wherein the silver (Ag) compound is silver (Ag) powder, and
the organophosphorus compound is organophosphate or organophosphonate.

5. The method of claim 1, wherein the organophosphorus compound has 8˜22 carbons.

6. An ink composition, comprising:
metal particles capped with a phosphorus (P) compound;
a solvent which disperses the metal particles;
a viscosity controlling agent which controls viscosity of ink; and
a dispersant which increases dispersibility of ink.

7. The ink composition of claim 6, wherein the metal particles capped with the phosphorus (P) compound are provided in a form wherein phosphorus (P) of the phosphorus (P) compound is adsorbed onto a surface of the metal particles.

8. The ink composition of claim 6, wherein the metal particles capped with the phosphorus (P) compound are provided in a form wherein a functional group of the phosphorus (P) compound is adsorbed onto a surface of the metal particles.

9. The ink composition of claim 6, wherein the metal particles are silver (Ag).

10. The ink composition of claim 6, wherein the viscosity controlling agent is added in an amount of 20 wt % or less based on a total weight of the ink composition.

11. The ink composition of claim 6, wherein the dispersant is added in an amount of 20 wt % or less based on a total weight of the ink composition.

12. The ink composition of claim 6, wherein an amount of the metal particles is 60 wt % or less based on a total weight of the ink composition.

13. A paste composition, comprising:
metal particles capped with a phosphorus (P) compound;
a solvent which disperses the metal particles; and
an organic binder.

14. The paste composition of claim 13, wherein the metal particles capped with the phosphorus (P) compound are provided in a form wherein phosphorus (P) of the phosphorus (P) compound is adsorbed onto a surface of the metal particles.

15. The paste composition of claim 13, wherein the metal particles capped with the phosphorus (P) compound are provided in a form wherein a functional group of the phosphorus (P) compound is adsorbed onto a surface of the metal particles.

16. The paste composition of claim 13, wherein the metal particles are silver (Ag).

17. The paste composition of claim 13, wherein an amount of the metal particles is 95 wt % or less based on a total weight of the paste composition.

18. The paste composition of claim 13, wherein the organic binder is added in an amount of 10 wt % or less based on a total weight of the paste composition.

19. The paste composition of claim 13, further comprising a thixotropic agent to adjust thixotropy of the paste composition.

20. The paste composition of claim 13, further comprising a plasticizer to adjust plasticity of the paste composition.
